(19) United States
(12) Patent Application Publication
(10) Pub. No.: US 2011/0129216 A1
(43) Pub. Date: Jun. 2, 2011

(54) Tunable optical filters

(76) Inventor: Christopher Lin, El Cerrito, CA (US)

(21) Appl. No.: 12/283,953

(22) Filed: Sep. 17, 2008

(51) Int. Cl. H04B 10/08; G02B 6/42

(52) U.S. Cl. 398/34; 385/31

(57) ABSTRACT

The specification describes tunable optical filters improved according to the invention by designing the optical system architecture to provide a double pass of the signal being analyzed through the tunable optical filter. The benefit of double passes through the tunable optical filter is narrower linewidth and better adjacent and non-adjacent channel isolation. The invention may be implemented with any tunable optical filter which is reciprocal. The optical system architecture is preferably an optical performance monitor for a WDM system.

### FIELD OF THE INVENTION

The invention relates to improvements in tunable filter architecture and more specifically to optical system monitoring with improved tunable optical filters.

### BACKGROUND OF THE INVENTION

There exists a well known category of optical devices that perform optical filtering and can be tuned to select a narrow band of wavelengths from a wider wavelength spectrum. These devices are used in a variety of optical systems. Of specific interest are wavelength division multiplexed systems that operate typically over wavelength bands of tens of nanometers. These systems require optical performance monitoring (OPM) to ensure that signal power, signal wavelength, and signal to noise ratios (OSNR) are within specified limits. Other applications for tunable optical filters, inter alia, are for optical noise filtering, noise suppression, and wavelength division multiplexing.

For the purpose of describing this invention the focus will be on tunable optical filters used in OPM systems, and OPM systems for wavelength division multiplexed (WDM) systems. It will be understood that the invention is not so limited.

In WDM systems, basic system design assumes wavelength stability. However, a variety of dynamic changes occur due to temperature changes, component aging, electrical power variations, etc. For optimum system performance it is necessary to monitor these changes and adjust system parameters to account for them. To accomplish this, optical channel monitors (OCMs), also known as optical performance monitors (OPMs), may be used to measure critical information for the various channels in the WDM system. OPMs may monitor signal dynamics, determine system functionality, identify performance change, etc. In each case they typically provide feedback for controlling network elements to optimize operational performance. More specifically, these tunable optical filters scan the C-, L- and/or C+L-band wavelength range and precisely measure channel wavelength, power, and optical signal-to-noise ratio (OSNR).

Performance parameters for tunable optical filters are likewise important for the effectiveness of OPMs. These include adjacent channel isolation and non-adjacent channel isolation. Adjacent channel isolation is the difference between the minimum point in the pass channel and the maximum point in the adjacent channels over all relevant polarization states and over the temperature range of the specification. Non-adjacent channel isolation is the difference between the minimum point in the pass channel and the maximum point of non-adjacent channels. It is also useful for tunable optical filters used in these monitors to have very narrow bandwidth. That produces more information as the signal band is scanned by the tunable optical filter. On the other hand, for measuring optical power in a selected channel over a wider bandwidth, a tunable filter with a correspondingly wider bandwidth makes that measurement simpler. This is among several trade-offs encountered in OPM design. There is also the ubiquitous trade-off of cost.

High performance tunable optical filters are often made using Fabry-Perot etalons. These can provide very good wavelength selectivity and narrow bandwidth, but they are expensive. Moreover, they tend to have poor non-adjacent channel isolation.

Another approach to OPM architecture is to use tunable optical filters with diffraction gratings and tilting mirrors. These can be made with good non-adjacent channel isolation but they typically have wide bandwidths. The bandwidth in these, designs can be narrowed but only by making the device very large.

Both wide bandwidth and good non-adjacent channel isolation are achievable using thin-film elements in the tunable optical filter. However, the thin film elements are difficult to manufacture and accordingly have high cost.

More cost effective approaches to the design of the tunable optical filters for OPMs is a desired goal.

### SUMMARY OF THE INVENTION

Prior art tunable optical filters may be improved according to the invention by designing the optical system architecture to provide a double pass of the signal being analyzed through the tunable optical filter. The benefit of double passes through the tunable optical filter is narrower linewidth and better adjacent and non-adjacent channel isolation. The invention may be implemented with any tunable optical filter which is reciprocal. This may be defined as a tunable optical filter in which the input and the output are interchangeable, and includes most types of known tunable optical filters.

### BRIEF DESCRIPTION OF THE DRAWING

The description of the invention below may be more easily understood when considered in conjunction with the drawing, in which:

FIG. 1 is a schematic representation of a WDM system with an OPM using a tunable optical filter;

FIG. 2 is a generalized schematic representation of a typical tunable optical filter subassembly used for conventional OPM;

FIG. 3 is a schematic representation of a first embodiment of the invention, and;

FIGS. 4-6 show alternative embodiments of the invention; and

FIG. 7 is a plot of filter characteristics showing some effects of the invention.

### DETAILED DESCRIPTION

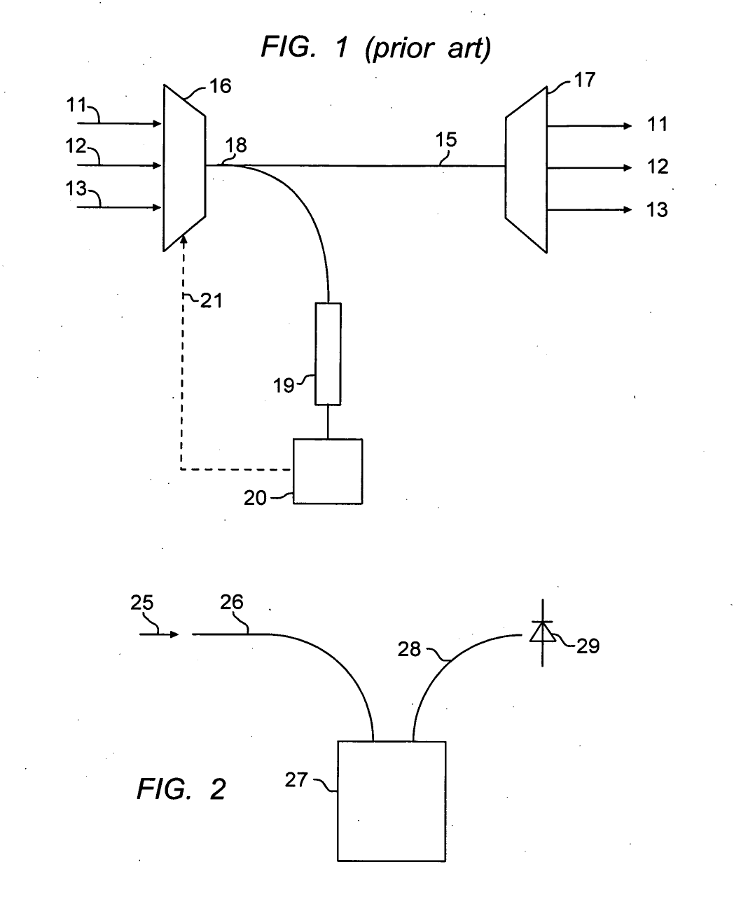

With reference to FIG. 1, a conventional approach to OPM in a WDM system is illustrated. As mentioned earlier, the description of the invention is focused on WDM systems as but one example of an application in which tunable optical filters are used for OPM, and the use of the invention to analyze and correct for wavelength drift etc. in the tunable optical filter of the OPM. For simplicity, FIG. 1 shows three channels 11,12, and 13. However, it is understood that typical WDM systems may have many more channels. FIG. 1 shows the transmission line 15 between multiplexer 16 at a sending site and demultiplexer 17 at the receiver. In one embodiment of OPM, the multiplexed signal is tapped, via tap 18, and the tapped signal is optically coupled to tunable optical filter 19 for analysis of the WDM signal to detect degradation. The tunable optical filter sweeps across all channels in the multiplexed signal, and reveals, for example, power changes in the individual channels of the signal. The power spectrum is measured by photodiode 20. Results are fed back via feedback loop 21 to the input stage for adjusting signal parameters to correct errors.

A generalized schematic of the tunable optical filter/detector subassembly is represented by FIG. 2, where the tapped signal 25 is conducted via optical fiber link 26 to tunable optical filter 27. The filtered signal is conducted via optical fiber link 28 to the detector. In the embodiment shown the detector is photodiode 29. The detector may comprise other known means for measuring the properties of the filtered light signal.

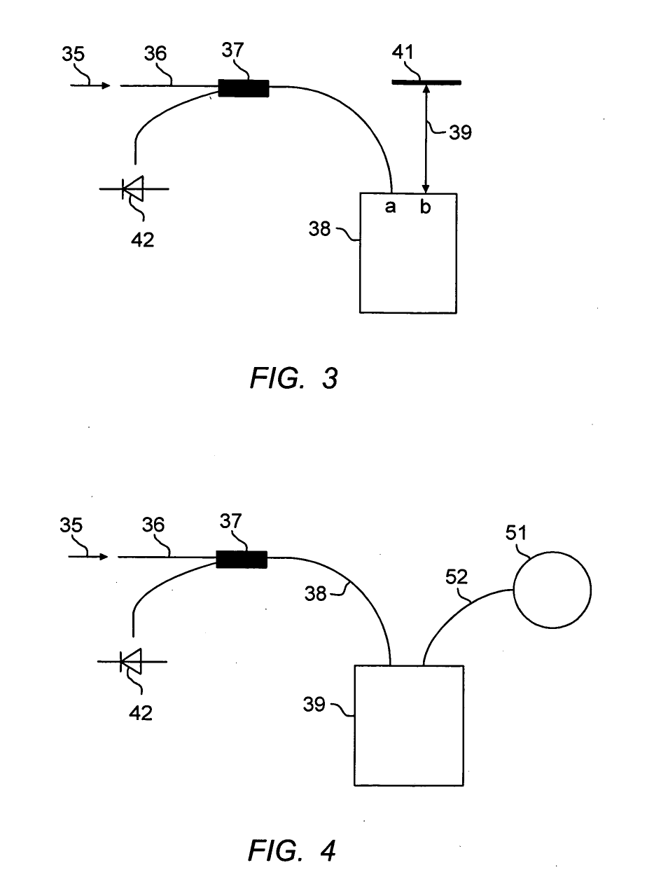

An embodiment of the invention is shown in FIG. 3, where light 35 that is tapped from the signal being analyzed is directed via optical fiber link 36 through an optical splitter 37 to tunable optical filter 38. The optical splitter may split in any suitable ratio but would typically be a 50-50 splitter. The output signal of the tunable optical filter is redirected back through the tunable optical filter using mirror 41 so that the light 35 is double passed through the tunable optical filter. The bi-directional coupling between the tunable optical filter 38 and the mirror 41, shown schematically at 39, may be an optical coupling through free space, or a waveguide coupler. The output of the tunable optical filter, which exits the tunable optical filter at the original input port, is directed back through the optical splitter 37 to photodiode 42.

A typical tunable optical filter is a two port reciprocal, device. Thus port “a” in FIG. 3, normally the input port becomes an I/O port for the modified tunable optical filter. Port “b” in FIG. 3, normally the output port, is an intermediate I/O port.

It will be recognized that the optical splitter comprises a 2 to 1 splitter, i.e. a splitter having a “two” side and a “one” side with one of the waveguides on the “two” side coupled to the input signal. The return signal from the double pass tunable optical filter is coupled to the waveguide on the “one” side of the splitter and is directed to the photodetector through the second waveguide on the “two” side. The splitter may be a fused optical fiber splitter, or other suitable element performing this function. While a 2:1 optical splitter is shown here for this function, alternative coupling and/or routing elements may be used. For example, a 2:2 optical splitter could be used with the second output used to measure total power for example. Furthermore, a circulator could be substituted for the 2:1 splitter shown in FIG. 3. In this case, the input light enters the first port of the circulator, exits the second port, returns into the second port after double passing through the tunable filter, and exits the third port whereupon it is measured using the photodetector.

FIG. 4 represents another embodiment of the invention wherein the mirror shown at 41 in FIG. 3 is replaced by an optical circulator 51, and the optical circulator is coupled to the tunable optical filter with bi-directional link 52 as in FIG. 4. The optical circulator is a conventional and well known device, functioning as an optical reflector.

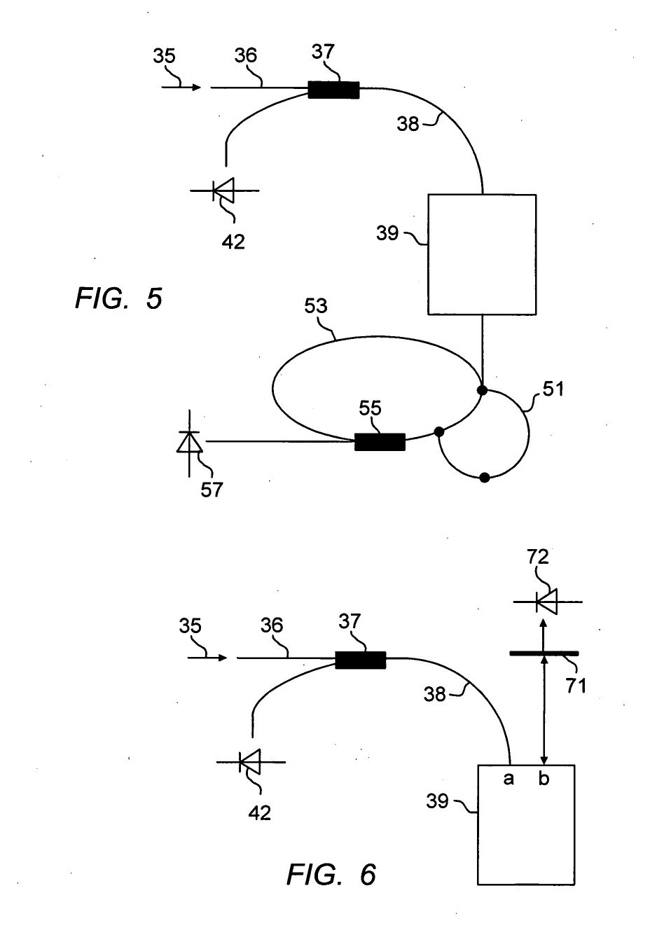

FIG. 5 illustrates another embodiment of the invention. This embodiment may be used to compare the operation of the conventional subassembly shown in FIG. 2 with the modified subassembly of FIG. 4. A beam splitter 55 is incorporated into a branch 53 of the optical circulator 51. The branch 53 contains the input to the optical circulator. Thus the light in this branch has passed once through the tunable optical filter. The single pass output of the beam splitter 55 is measured by photodiode 57, and the measurement is equivalent to that from photodiode 29 in FIG. 2. That output can be compared to the output from photodiode 42 to show the difference between light undergoing a single pass through tunable optical filter 39, and light undergoing a double pass through the tunable optical filter. The comparison will show that the bandwidth of the light from the double pas is narrower than that of the light that undergoes a single pass. It may also show improved adjacent and non-adjacent channel suppression, and improved dynamic range, especially improved differential dynamic range. Differential dynamic range is the extent to which channels of different power levels may be distinguished.

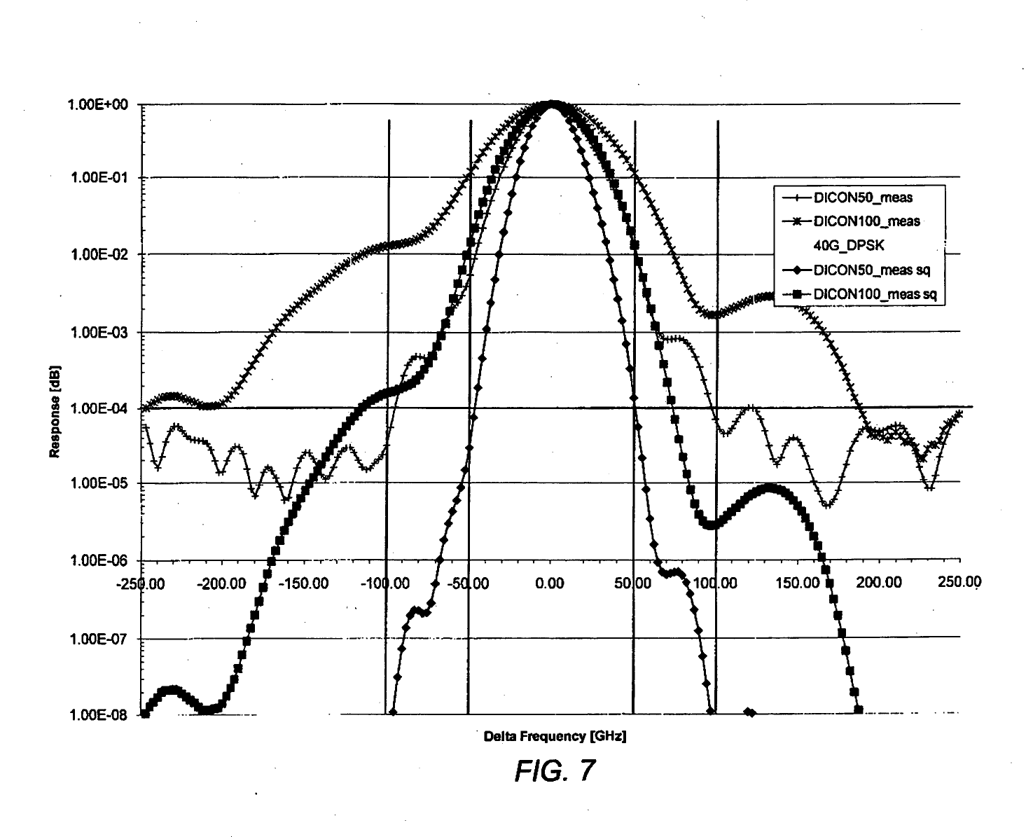

Results of one comparison of single pass filter results with double pass filter results are shown in FIG. 7. The data points shown by a cross were taken using a DiCon 50 MEMS filter, and a single pass of signal light through the filter. The filtered bandwidth at 1E-04 is approximately 200 GHz. For comparison, data points for that signal passed twice through the DiCon 50 filter are shown by a diamond, and indicate a narrower linewidth at 1E-04 of approximately 100 GHz. Similar comparative data is shown in FIG. 7 for a DiCon 100 MEMS filter. The points indicated by asterisks give data for a single pass, while the data points indicated by squares give data for a double pass. Again substantial line narrowing occurs in the case of the double pass.

The embodiment of FIG. 5, where both the single pass and the double pass signals are available, allows a simpler measurement of signal power when the bandwidth of the signal is wider than a double pass, but narrower than a single pass. In this case, measurement of some parameters such as signal power is advantageously performed with a single pass through the filter, whereas measurement of other parameters such as OSNR are advantageously performed with a double pass through the filter.

FIG. 6 shows an alternative embodiment, similar to that of FIG. 5, wherein the circulator 51 is replaced by a partially reflecting mirror 71, with photodiode 72 placed to detect the portion of the single pass filtered signal that passes through the mirror. It will be recognized that the power in the signal being detected at either of the detectors, 42 and 72, is attenuated by comparison to that of signal 35, but the sum of the powers detected represents the power in signal 35. If desired, simple software may be used to compensate for the attenuation.

As mentioned above, the tunable optical filter may be one of a variety of designs, both known or to be developed, which operate as reciprocal devices. An example of this form of device is described in U.S. Pat. No. 5,917,626, issued Jun. 29, 1999. This tunable optical filter is based on controlling the distance between an input optical path and the axis of a GRIN lens and using the lens to transmit the beam to an interference filter. The filter passes spectral components within the characteristic wavelength band and reflects spectral components outside the characteristic wavelength band. The pass and rejection bands of the filter can be easily tuned to form a tunable optical filter useful in WDM multiplexers and demultiplexers. The wavelength band varies with the angle of incidence of light to the normal direction to the filter. The filter has means for directing the optical signal along an input optical path substantially parallel to the axis of the GRIN lens at a distance from the axis, and adjusting the distance so that a spectral component in the first input optical signal transmitted by the lens is passed or reflected by the filter. More details on this device may be found in the cited patent, which is incorporated herein by reference.

Another suitable category of tunable optical filters is MEMS filters. An example of this type of tunable optical filter is described in U.S. Pat. No. 6,373,632, issued Apr. 16, 2002, also incorporated herein by reference. More information on this category of devices is available through:
http://www.axsun.com/html/products_omx_telecom.htm

Several known tunable optical filter designs include a photodetector element integrated with the tunable optical filter. This physically restricts access to the tunable optical filter in such a way as to prevent a convenient means for providing a double pass through the tunable optical filter, as described above. In most such cases it is only necessary, in order to implement this invention, to disintegrate the tunable optical filter and the photodetector and insert a reflective element in between.

In general, a tunable optical filter is an optical filter that can be tuned over a wavelength range of at least 10 nm. A typical tunable optical filter will filter an input optical band of, for example 1550 nm to 1580 nm, to channels of one or a few nm over that optical band. Tuning may be effected by changing an electrical operating parameter of the tunable optical filter (e.g. voltage or current), by mechanically changing the physical structure of the device, by heating or cooling the device, etc.

The term “reflective element” as used herein is intended to designate an element by its function. Thus, while a mirror is a very commonly known reflective element, an optical circulator may be a reflective element in the context of its function. The step of reflecting the output of the tunable optical filter back into the tunable optical filter for a second pass through the tunable optical filter will normally have no intervening signal processing, i.e., the once filtered optical signal is filtered again without changing the characteristics or the properties of the once filtered optical signal. In the device context, the device will have no signal processing elements between the reflecting element and the tunable optical filter.

In the preferred embodiment, the optical band that is delivered to the input port of the tunable optical filter is a signal tapped from the WDM system being monitored. The tapped signal may be the entire WDM band, or one channel or a group of channels. The tapped WDM signal may be modulated, i.e. tapped after the modulator, or unmodulated, i.e. tapped before the modulator.

In the preferred embodiments of the invention the OPM is implemented using optical fiber assemblies and components. However, one or more elements and steps of the OPM system and method may involve other forms of waveguides. For example, an optical integrated circuit may be used to route the optical signals through the tunable optical filter.

In describing the relationship between the reflecting element and the output port of the tunable optical filter, the relationship may be a physical coupling or a free space relationship. In the case where the reflecting element comprises one or more mirrors the reflecting element may simply be optically aligned with the intermediate I/O port of the tunable optical filter. For more precision performance and versatility the intermediate I/O port of the tunable optical filter may be coupled to one or more mirrors through an optical fiber link. If the reflecting element is an optical circulator, that element would normally be coupled to and from the output port of the tunable optical coupler by one or more optical fiber links. The term “coupled” in the context of the invention means optically coupled in any suitable manner.

Various additional modifications of this invention will occur to those skilled in the art. All deviations from the specific teachings of this specification that basically rely on the principles and their equivalents through which the art has been advanced are properly considered within the scope of the invention as described and claimed.

1. Method comprising:
a) coupling an optical band to the input port of a tunable optical filter for a first pass through the tunable optical filter, the tunable optical filter comprising an input port and an output port,
b) adjusting the tunable optical filter to pass a portion of the optical band and produce a single pass filtered optical signal at the output port of the tunable optical filter,
c) coupling the single pass filtered optical signal at the output port of the to tunable optical filter to a reflecting element,
d) reflecting the single pass filtered optical signal back to the output port of the tunable optical filter,
e) passing the single pass filtered optical signal through the tunable optical filter for a second pass through the tunable optical filter to produce a double pass filtered optical signal,
f) measuring one or more characteristics of the double pass filtered optical signal.

2. The method of claim 1 wherein the reflecting element comprises one or more mirrors.

3. The method of claim 1 wherein the reflecting element comprises an optical circulator.

4. The method of claim 1 wherein the properties of the single pass filtered optical signal are not changed between the first pass and the second pass.

5. The method of claim 1 additionally including measuring one or more properties or characteristics of the single pass filtered optical signal.

6. The method of claim 1 wherein the method includes monitoring the performance of an optical system.

7. The method of claim 6 wherein the optical system is a WDM system and the method additionally includes the step of producing the optical band by tapping an optical signal from the WDM system.

8. Device comprising:
a) a tunable optical filter comprising an input port and an output port,
b) an optical waveguide for coupling an optical band to the input port of the tunable optical filter,
c) an adjustment means for adjusting the tunable optical filter to pass a portion of the optical band and produce a single pass filtered optical signal at the output port of the tunable optical filter,
d) a reflecting element coupled to the output port of the optical filter for reflecting the single pass filtered optical signal back through the tunable optical filter to the input port of the tunable optical filter,
e) a first photodetector coupled to the input port of the tunable optical filter for measuring one or more properties or characteristics of light exiting from the input port.

9. The device of claim 8 wherein the reflecting element comprises one or more mirrors.

10. The device of claim 8 wherein the reflecting element comprises an optical circulator.

11. The device of claim 8 wherein the reflecting element is coupled directly to the tunable optical filter with no added signal processing elements in between.

12. The device of claim 8 additionally including a second photodetector coupled to the reflecting element for measuring one or more properties or characteristics of the single pass filtered optical signal.

13. The device of claim 12 comprising an optical splitter in said optical waveguide and an optical splitter coupled to said reflecting element.

14. The device of claim 8 wherein the photodetector is a photodiode.

15. A wavelength division multiplexed (WDM) system having an optical performance monitor (OPM) wherein the OPM comprises:
a) a tunable optical filter comprising an input port and an output port,
b) an optical waveguide for coupling a WDM optical band to the input port of the tunable optical filter,
c) an adjustment means for adjusting the tunable optical filter to pass a portion of the optical band and produce a single pass filtered optical signal at the output port of the tunable optical filter,
d) a reflecting element coupled to the output port of the optical filter for reflecting the single pass filtered optical signal back through the tunable optical filter to the input port of the tunable optical filter,
e) a first photodetector coupled to the input port of the tunable optical filter for measuring one or more properties or characteristics of light exiting from the input port.
